(19) United States
(12) Patent Application Publication
(10) Pub. No.: US 2022/0100906 A1
(43) Pub. Date: Mar. 31, 2022

(54) SOFTWARE LIBRARY INTEGRITY VERIFICATION MECHANISM

(71) Applicant: Intel Corporation, Santa Clara, CA (US)

(72) Inventors: Vasanth Kumar Nagaraja, Bangalore (IN); Taj un nisha N, TamilNadu (IN); Vasavi V, Bangalore (IN)

(73) Assignee: Intel Corporation, Santa Clara, CA (US)

(21) Appl. No.: 17/545,157

(22) Filed: Dec. 8, 2021

(51) Int. Cl. G06F 21/72; G06F 21/60; G06F 21/54; G06F 21/57

(52) U.S. Cl. CPC G06F 21/72; G06F 21/577; G06F 21/54; G06F 21/602

(57) ABSTRACT

An apparatus is disclosed. The apparatus comprises a processor to generate a launch control policy (LCP) comprising a plurality of measured launch environment (MLE) elements associated with one or more libraries of a software application and a cryptographic processor to deploy the LCP to generate root of trust (ROT) measurements, wherein the processor to perform launch verification to execute the one or more libraries upon execution and to verify integrity of the one or more libraries based on the associated MLEs and the ROT measurements.

### BACKGROUND OF THE DESCRIPTION

Software applications executed on an operating system are susceptible to maliciously modified programs being executed under the disguise of genuine applications. Currently, software development is accomplished using shared libraries. Compromised libraries are a great security risk to computing platforms. Specifically, modified (or malicious) libraries loaded as part of application execution poses a threat to platform assets.

### BRIEF DESCRIPTION OF THE DRAWINGS

So that the manner in which the above recited features of the present embodiment can be understood in detail, a more particular description of the embodiment, briefly summarized above, may be had by reference to embodiments, some of which are illustrated in the appended drawings. It is to be noted, however, that the appended drawings illustrate only typical embodiments of this embodiment and are therefore not to be considered limiting of its scope, for the embodiment may admit to other equally effective embodiments.

FIG. 1 illustrates one embodiment of a computing device.

FIG. 2 illustrates one embodiment of a platform.

FIG. 3 illustrates one embodiment of software library integrity verification logic.

FIG. 4 illustrates one embodiment of a process to derive initial measurements of respective software libraries.

FIG. 5 is a flow diagram illustrating one embodiment of a process for a launch verification process.

FIG. 6 is a flow diagram illustrating one embodiment of a software library integrity verification process.

FIG. 7 illustrates one embodiment of a schematic diagram of an illustrative electronic computing device.

### DETAILED DESCRIPTION

In the following description, numerous specific details are set forth to provide a more thorough understanding of the present embodiment. However, it will be apparent to one of skill in the art that the present embodiment may be practiced without one or more of these specific details. In other instances, well-known features have not been described in order to avoid obscuring the present embodiment.

In embodiments, a mechanism is provided to ensure that software programs dependent on software libraries are able to detect potentially malicious libraries from being loaded into a platform. As used herein, a software library may be defined as a collection of non-volatile resources used by computer programs. A software library may include configuration data, documentation, help data, message templates, pre-written code and subroutines, classes, values or type specifications.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to and are not intended to imply that the elements so described must be in a given sequence, either temporally, spatially, in ranking, or in any other manner.

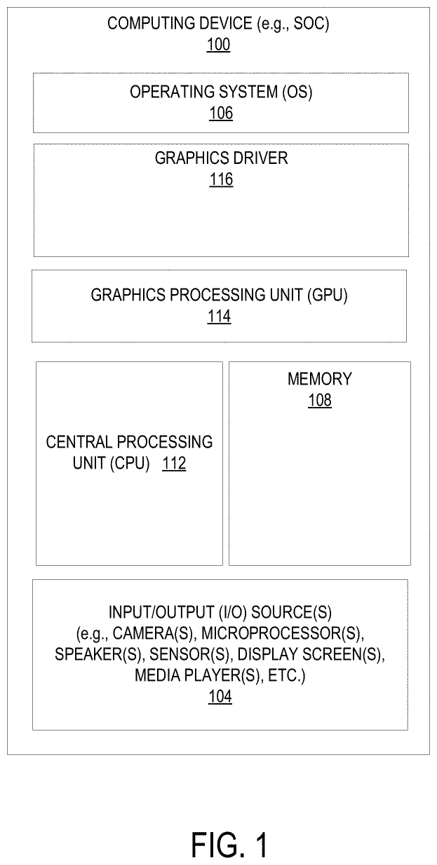

FIG. 1 illustrates one embodiment of a computing device 100. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

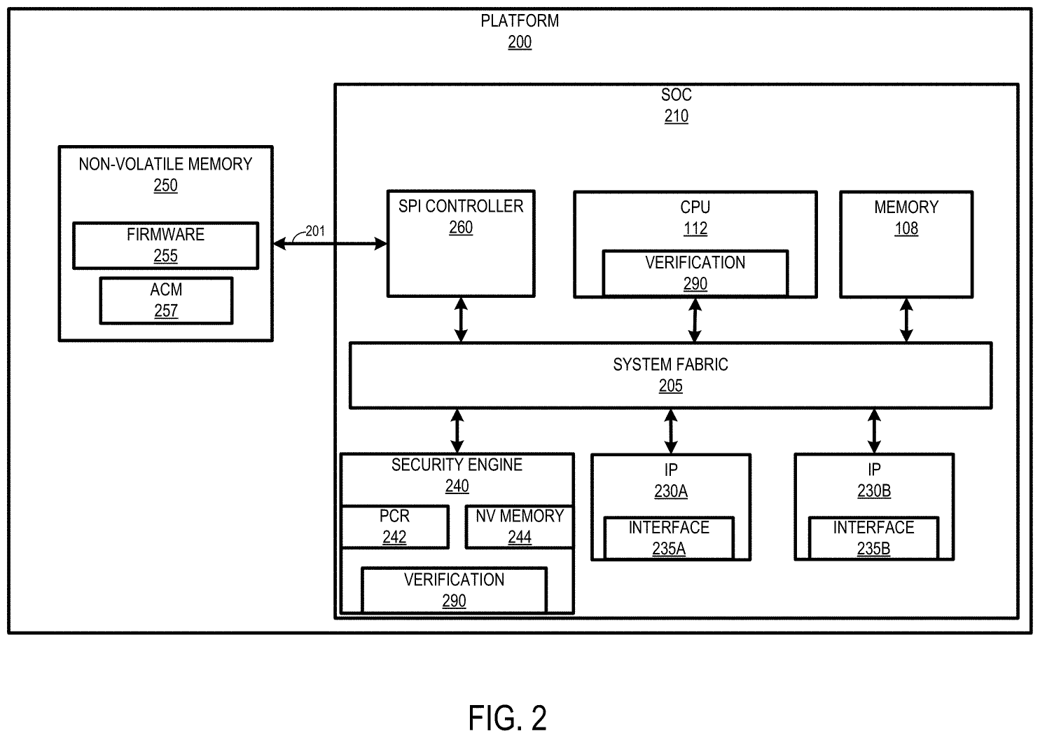

FIG. 2 illustrates one embodiment of a platform 200 including a SOC 210 similar to computing device 100 discussed above. As shown in FIG. 2, SOC 210 includes other computing device components (e.g., memory 108 and CPU 112) coupled via a system fabric 205. In one embodiment, system fabric 205 comprises an integrated on-chip system fabric (IOSF) to provide a standardized on-die interconnect protocol for coupling interconnect protocol (IP) agents 230 (e.g., IP agents 230A and 230B) within SOC 210. In such an embodiment, the interconnect protocol provides a standardized interface to enable third parties to design logic such as IP agents to be incorporated in SOC 210.

According to embodiment, IP agents 230 may include general purpose processors (e.g., in-order or out-of-order cores), fixed function units, graphics processors, I/O controllers, display controllers, etc. In such an embodiment, each IP agent 230 includes a hardware interface 235 (e.g., 235A and 235B) to provide standardization to enable the IP agent 230 to communicate with SOC 210 components. For example, in an embodiment in which IP agent 230 is a third-party visual processing unit (VPU), interface 235 provides a standardization to enable the VPU to access memory 108 via fabric 205.

Further, SOC 210 is coupled to a non-volatile memory 250. Non-volatile memory 250 may be implemented as a Peripheral Component Interconnect Express (PCIe) storage drive, such as a solid-state drive (SSD) or Non-Volatile Memory Express (NVMe) drives. In one embodiment, non-volatile memory 250 is implemented to store the platform 200 firmware 255. In one embodiment, SOC 210 is coupled to non-volatile memory 250 via a serial peripheral interface (SPI) 201. In such an embodiment, SOC 210 includes SPI controller 260 coupled between SPI 201 and system fabric 205. In a further embodiment, SPI controller 260 is a flash controller implemented to control access to non-volatile memory 250 via SPI 201.

SOC 210 also includes a security engine 240 that performs various security operations (e.g., security processing, cryptographic functions, etc.) for SOC 210. In one embodiment, security engine 240 comprises an IP agent 230 that is implemented to perform the security operations. In one embodiment, security engine 240 is a cryptographic processor that is implemented as a Trusted Platform Module (TPM) which operates as a root of trust (or platform ROT) to assure the integrity of hardware and software operating on platform 200. In such an embodiment, the ROT stores and reports measurements that are used for reporting and evaluating the current platform 200 configuration and for providing long-term protection of sensitive information. As used herein, a ROT is defined as a set of functions in a trusted computing module within a host that is always trusted by the host's operating system (OS). The ROT serves as separate compute engine controlling the trusted computing platform cryptographic processor, such as security engine 240, on platform 200.

As discussed above, compromised software libraries executed as components of an application pose a security risk to platform 200. Existing solutions are software-based, eventually leaving hackers with additional opportunities for exploitation since there is a risk involved in software-based solutions. Further, complex software-based infrastructures have larger attack surfaces and more potential vulnerabilities.

According to one embodiment, software library integrity verification logic (or verification logic) 290 is implemented to perform hardware-based authentication to ensure the integrity of software libraries prior to being loaded by the platform 200 operating system. In a further embodiment, verification logic 290 verifies the integrity of the software libraries using a Dynamic Root of Trust for Measurement (DRTM) prior to being loaded by the platform 200 operating system. DRTM provides evidence of trusted platform 200 state at points in time other than just during platform startup.

In one embodiment, CPU 112 is configured to execute a security instruction that performs multiple functions to securely validate an authenticated code module (ACM) 257 within non-volatile memory 250 and invoke authenticated code using a secure area within CPU 112 that is protected from external influence. ACM 257 comprises code created and digitally signed with a private key that is only known to the CPU 112 manufacturer and invoked as discussed above. In one embodiment, ACM 257 comprises a basic input/output system (“BIOS”) ACM that measures the system BIOS and performs several BIOS-based security functions.

In a further embodiment, ACM 257 also comprises a secure initialization (SINIT) ACM that is called by OS 106 or applications running under the OS 106 to perform a measured launch (e.g., DRTM). As discussed above, security engine 240 performs as a TPM to provide a ROT for storing and reporting ROT measurements (or measurements). In one embodiment, security engine 240 includes platform configuration registers (PCRs) 242 to store ROT measurement values and a non-volatile memory 244. As illustrated, in one embodiment, verification logic 290 may be hosted by or part of CPU 112 and/or security engine 240. However in other embodiments, verification logic 290 may be hosted by or part of one or more IPs 230.

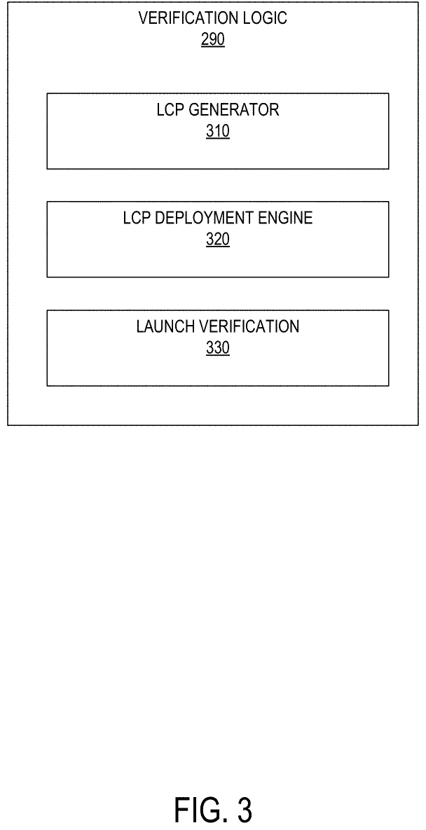

FIG. 3 illustrates one embodiment of verification logic 290. As shown in FIG. 3, verification logic 290 includes a launch control policy (LCP) generator 310, LCP deployment engine 320 and launch verification engine 330. In one embodiment, an LCP comprises a verification mechanism for a verified launch process, and is used to determine whether a current platform configuration or an environment to be launched meets a specified criteria. An LCP comprises an LCP Policy Engine, LCP policy and an LCP policy data file.

In one embodiment, the LCP Policy Engine is a component of the SINIT ACM, which enforces the policies stored on the platform. The LCP Policy comprises a policy that takes a form of structure residing in non-volatile memory 244 within security engine 240. In one embodiment, the policy structure defines some of the policies and creates a linkage to the LCP policy data file. The LCP policy data file is structured to be a nested collection of lists and valid policy elements, such as measurements of measured launch environments (MLEs) (or trusted OSs), platform configurations, and other objects.

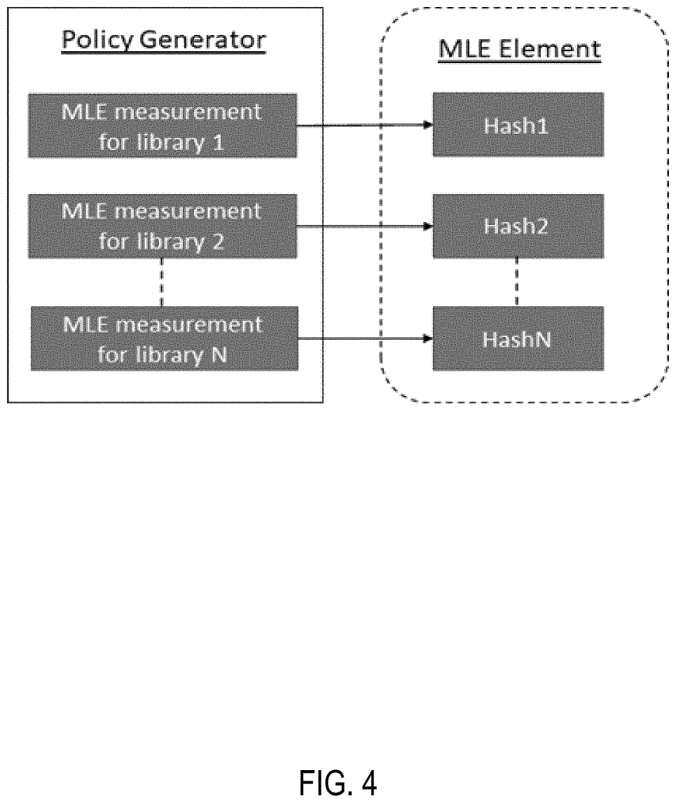

According to one embodiment, LCP generator 310 generates an MLE policy element associated with each library. In such an embodiment, each MLE policy element comprises a policy list and provides a mechanism to cryptographically sign the policy list. In a further embodiment, an MLE element also includes the measurements/hash values of an associated native library that would be loaded by the software program during execution. FIG. 4 illustrates one embodiment of MLE elements generated by LCP generator 310. LCP generator 310 also assembles policy lists to generate the policy data structure and nonvolatile policy data. The nonvolatile policy data comprises the hash measurement of the policy data structure and is stored in non-volatile memory 244 within security engine 240.

LCP deployment engine 320 deploys the generated LCP to enable platform 200 to generate measurement credentials that are used to complete the trust verification process. In one embodiment, PCR 242 includes measurement values associated with a MLE that are used to make the trust decision in order to gain trust in MLE. In such an embodiment, the trust decision is made via local attestation (e.g., the release of some data that is not available to untrusted software. However in other embodiments, the trust decision may be made via remote attestation (e.g., a party external to the MLE's system).

In local attestation, security engine 240 is used to store data to an associated PCR 242 as measurement values. In one embodiment, the data is sealed when in a trusted state and a PCR/binding made to values that represent a desired trusted state. In such an embodiment, the initial and final states do not have to be the same as long as they are both trusted. In a further embodiment, the sealed data is persistently stored so it can be retrieved and unsealed when the trusted MLE is running. The above processed may be referred to as a seal operation.

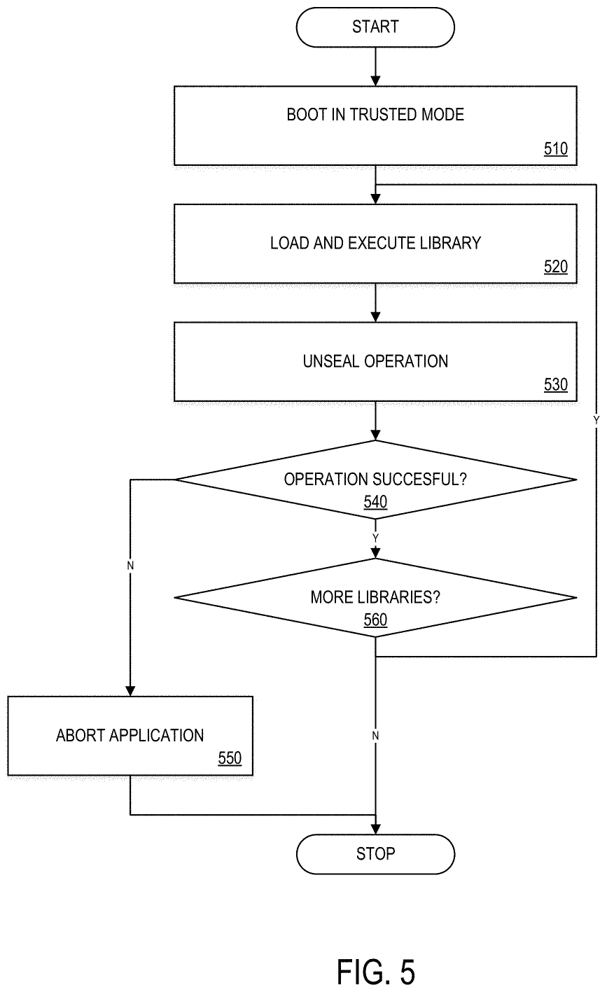

Once the LCP has been deployed via the seal operation, the expected measurements of the dependent libraries are available at the non-volatile memory 244. Launch verification engine 330 is implemented to load/execute each dependent library and make trust decisions using the associated library MLEs. FIG. 5 is a flow diagram illustrating one embodiment of a process for a launch verification process. At processing block 510, the OS is booted in trusted mode sometime after the LCP has been deployed. Sometime later, execution of the software application begins. When the software application intends to load a library to perform a specific function, the application calls an OS routine to load and execute the library, processing block 520.

At processing block 530, the OS invokes a TPM unseal operation to verify the integrity of the dependent library. At decision block 540, a determination is made as to whether the TPM unseal operation is successful. In one embodiment, the unseal operation comprises retrieving expected ROT measurements from non-volatile memory 244 (e.g., PCR 242 ROT measurements when the LCP was deployed), and comparing the expected the ROT measurements with current PCR 242 ROT measurements. The TPM unseal operation is determined to be successful upon a determination that current PCR 242 measurements match the expected the ROT measurements.

Upon a determination that the TPM unseal operation is unsuccessful, an abort operation is performed to terminate the application, processing block 550. Upon a determination at decision block 540 that the TPM unseal operation is successful, a determination is made as to whether there are additional libraries to execute, decision block 560. If so, control is returned to processing block 520 for a subsequent library to be loaded. Otherwise, the process has been completed.

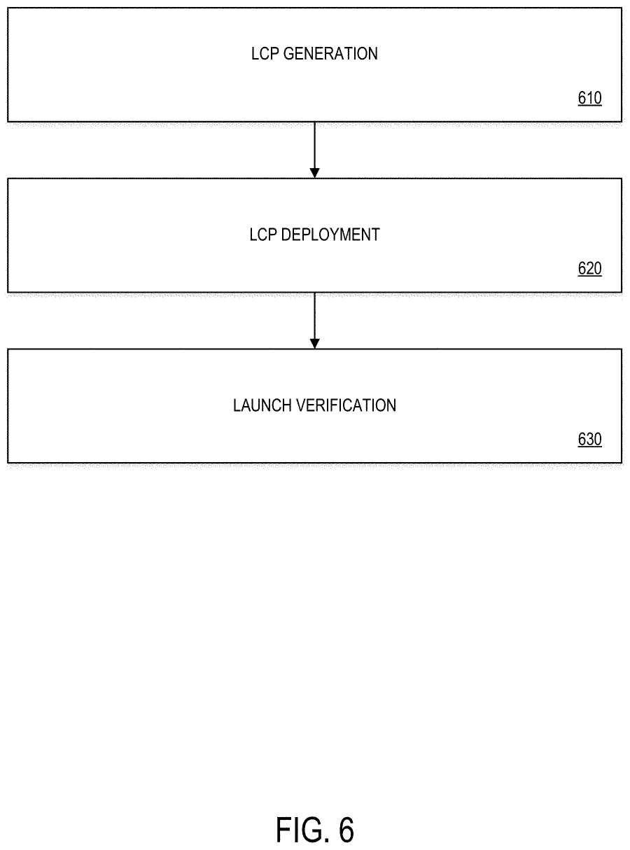

FIG. 6 is a flow diagram illustrating one embodiment of a library software library integrity verification process. At processing block 610, LCP generation is performed. As discussed above, LCP generation is implemented to generate a policy list that includes an MLE policy element and means to sign the policy list and assemble the policy lists into a policy data structure and nonvolatile policy data. At processing block 620, a seal operation is performed to deploy the LCP. At processing block 630, launch verification is performed.

The above-described mechanism ensures that a software program dependent on other software libraries for its execution is able to detect potentially malicious libraries from being loaded. Consequently, the mechanism ensures the integrity of the libraries before loading thereby allowing only genuine libraries to be loaded prior execution.

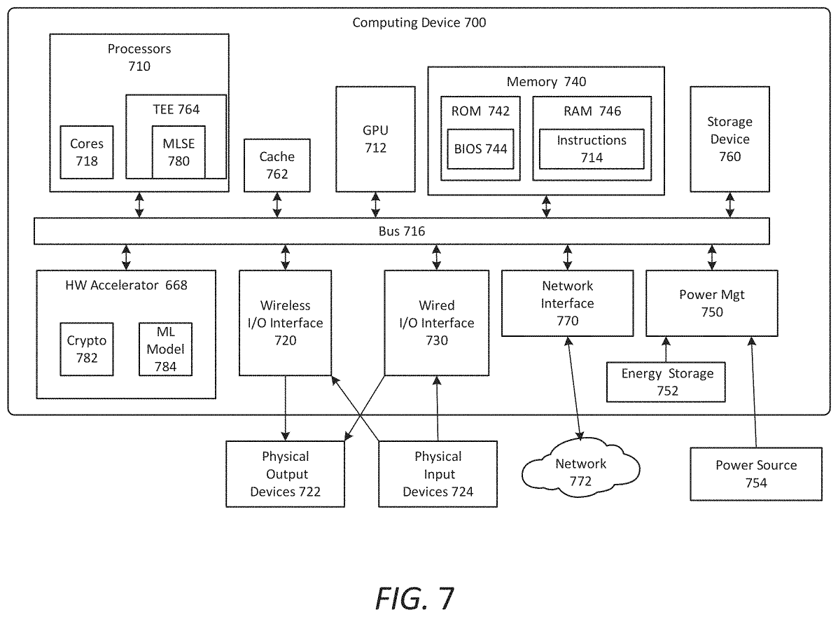

FIG. 7 illustrates one embodiment of a schematic diagram of an illustrative electronic computing device. In some embodiments, the computing device 700 includes one or more processors 710 including one or more processors cores 718 and a TEE 764, the TEE including a machine learning service enclave (MLSE) 780. In some embodiments, the computing device 700 includes a hardware accelerator 768, the hardware accelerator including a cryptographic engine 782 and a machine learning model 784. In some embodiments, the computing device is to provide enhanced protections against ML adversarial attacks, as provided in FIGS. 1-6.

The computing device 700 may additionally include one or more of the following: cache 762, a graphical processing unit (GPU) 712 (which may be the hardware accelerator in some implementations), a wireless input/output (I/O) interface 720, a wired I/O interface 730, memory circuitry 740, power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, or similar device or system.

In embodiments, the processor cores 718 are capable of executing machine-readable instruction sets 714, reading data and/or instruction sets 714 from one or more storage devices 760 and writing data to the one or more storage devices 760. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 718 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 700 includes a bus or similar communications link 716 that communicably couples and facilitates the exchange of information and/or data between various system components including the processor cores 718, the cache 762, the graphics processor circuitry 712, one or more wireless I/O interfaces 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 7 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random-access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, or similar.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include but are not limited to: universal serial bus (USB), IEEE 1394 (“FireWire”), and similar.

The computing device 700 may include one or more communicably coupled, non-transitory, data storage devices 760. The data storage devices 760 may include one or more hard disk drives (HDDs) and/or one or more solid-state storage devices (SSDs). The one or more data storage devices 760 may include any current or future developed storage appliances, network storage devices, and/or systems. Non-limiting examples of such data storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 760 may include one or more removable storage devices, such as one or more flash drives, flash memories, flash storage units, or similar appliances or devices capable of communicable coupling to and decoupling from the computing device 700.

The one or more data storage devices 760 may include interfaces or controllers (not shown) communicatively coupling the respective storage device or system to the bus 716. The one or more data storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or Wi-Fi®, etc.).

Processor-readable instruction sets 714 and other programs, applications, logic sets, and/or modules may be stored in whole or in part in the system memory 740. Such instruction sets 714 may be transferred, in whole or in part, from the one or more data storage devices 760. The instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a processor to generate a launch control policy (LCP) comprising a plurality of measured launch environment (MLE) elements associated with one or more libraries of a software application and a cryptographic processor to deploy the LCP to generate root of trust (ROT) measurements, wherein the processor to and perform launch verification to execute the one or more libraries upon execution and to verify integrity of the one or more libraries based on the associated MLEs and the ROT measurements.

Example 2 includes the subject matter of Example 1, wherein an MLE element comprises hash values of an associated library.

Example 3 includes the subject matter of Examples 1 and 2, the cryptographic processor comprises a platform configuration register (PCR) to store the ROT measurements.

Example 4 includes the subject matter of Examples 1-3, wherein deploying the LCP comprises storing the expected ROT measurements in a non-volatile memory.

Example 5 includes the subject matter of Examples 1-4, wherein performing the launch verification comprises executing a first library and invoking an unseal operation to verify the integrity of the first library.

Example 6 includes the subject matter of Examples 1-5, wherein the unseal operation comprises retrieving the expected ROT measurements associated with the first library from the non-volatile memory and comparing the ROT measurements with the current PCR ROT measurement associated with the first library.

Example 7 includes the subject matter of Examples 1-6, wherein performing the launch verification further comprises determining whether the unseal operation is successful.

Example 8 includes the subject matter of Examples 1-7, wherein the unseal operation is successful upon a determination that the expected ROT measurements match the current PCR ROT measurements associated with the first library.

Example 9 includes the subject matter of Examples 1-8, wherein the unseal operation is unsuccessful upon a determination that the expected ROT measurements do not match current PCR ROT measurements.

Example 10 includes the subject matter of Examples 1-9, wherein performing the launch verification further comprises performing an abort operation to terminate the application upon a determination that the unseal operation is unsuccessful.

Example 11 includes the subject matter of Examples 1-10, wherein the LCP comprises a policy engine to enforce platform polices, a policy and a policy data file.

Example 12 includes the subject matter of Examples 1-11, wherein a MLE element comprises a trusted operating system.

Some embodiments pertain to Example 13 that includes a method comprising generating a launch control policy (LCP) comprising a plurality of measured launch environment (MLE) elements associated with one or more libraries of a software application, deploying the LCP including expected root of trust (ROT) measurements; and performing launch verification to execute the one or more libraries upon execution and verify integrity of the one or more libraries based on the associated MLEs and the ROT measurements.

Example 14 includes the subject matter of Example 13, wherein deploying the LCP comprises storing the expected ROT measurements in a non-volatile memory.

Example 15 includes the subject matter of Examples 13-14, wherein performing the launch verification comprises executing a first library and invoking an unseal operation to verify to integrity of the first library.

Example 16 includes the subject matter of Examples 13-15, wherein the unseal operation comprises retrieving the expected ROT measurements associated with the first library from the non-volatile memory and comparing the expected ROT measurements with current PCR ROT measurements associated with the first library.

Example 17 includes the subject matter of Examples 13-16, wherein performing the launch verification further comprises determining whether the unseal operation is successful.

Example 18 includes the subject matter of Examples 13-17, wherein the unseal operation is successful upon a determination that the expected ROT measurements match the current PCR ROT measurements associated with the first library.

Example 19 includes the subject matter of Examples 13-18, wherein the unseal operation is unsuccessful upon a determination that the expected ROT measurements do not match current PCR ROT measurements.

Some embodiments pertain to Example 20 that includes at least one computer readable medium having instructions stored thereon, which when executed by one or more processors, cause the processors to generate a launch control policy (LCP) comprising a plurality of measured launch environment (MLE) elements associated with one or more libraries of a software application, deploy the LCP to generate root of trust (ROT) measurements and perform launch verification to execute the one or more libraries upon execution and verify integrity of the one or more libraries based on the associated MLEs and the ROT measurements.

Example 21 includes the subject matter of Example 20, wherein deploying the LCP comprises storing the expected ROT measurements in a non-volatile memory.

Example 22 includes the subject matter of Examples 20 and 21, wherein performing the launch verification comprises executing a first library and invoking an unseal operation to verify to integrity of the first library.

Example 23 includes the subject matter of Examples 20-22, wherein the unseal operation comprises retrieving the expected ROT measurements associated with the first library from the non-volatile memory and comparing the expected ROT measurements with current PCR ROT measurements associated with the first library.

The embodiment has been described above with reference to specific embodiments. Persons skilled in the art, however, will understand that various modifications and changes may be made thereto without departing from the broader spirit and scope of the embodiment as set forth in the appended claims. The foregoing description and drawings are, accordingly, to be regarded in an illustrative rather than a restrictive sense.

What is claimed is:

1. An apparatus comprising:
a processor to generate a launch control policy (LCP) comprising a plurality of measured launch environment (MLE) elements associated with one or more libraries of a software application; and
a cryptographic processor to deploy the LCP that includes expected root of trust (ROT) measurements,
wherein the processor to perform launch verification to execute the one or more libraries upon software execution and to verify integrity of the one or more libraries based on the associated MLE elements and the ROT measurements.

2. The apparatus of claim 1, wherein an MLE element comprises hash values of an associated library.

3. The apparatus of claim 2, the cryptographic processor comprises a platform configuration register (PCR) to store the ROT measurements.

4. The apparatus of claim 3, wherein deploying the LCP comprises storing the expected ROT measurements in a non-volatile memory.

5. The apparatus of claim 4, wherein performing the launch verification comprises executing a first library and invoking an unseal operation to verify the integrity of the first library.

6. The apparatus of claim 5, wherein the unseal operation comprises retrieving the expected ROT measurements associated with the first library from the non-volatile memory, and comparing the ROT measurements with the current PCR ROT measurement associated with the first library.

7. The apparatus of claim 6, wherein performing the launch verification further comprises determining whether the unseal operation is successful.

8. The apparatus of claim 7, wherein the unseal operation is successful upon a determination that the expected ROT measurements match the current PCR ROT measurements associated with the first library.

9. The apparatus of claim 8, wherein the unseal operation is unsuccessful upon a determination that the expected ROT measurements do not match current PCR ROT measurements.

10. The apparatus of claim 9, wherein performing the launch verification further comprises performing an abort operation to terminate the application upon a determination that the unseal operation is unsuccessful.

11. The apparatus of claim 1, wherein the LCP comprises a policy engine to enforce platform polices, a policy and a policy data file.

12. The apparatus of claim 11, wherein a MLE element comprises a trusted operating system.

13. A method comprising:
generating a launch control policy (LCP) comprising a plurality of measured launch environment (MLE) elements associated with one or more libraries of a software application;
deploying the LCP including expected root of trust (ROT) measurements; and
performing launch verification to execute the one or more libraries upon execution and verify integrity of the one or more libraries based on the associated MLEs and the ROT measurements.

14. The method of claim 13, wherein deploying the LCP comprises storing the expected ROT measurements in a non-volatile memory.

15. The method of claim 14, wherein performing the launch verification comprises executing a first library and invoking an unseal operation to verify to integrity of the first library.

16. The method of claim 15, wherein the unseal operation comprises:
retrieving the expected ROT measurements associated with the first library from the non-volatile memory; and
comparing the expected ROT measurements with current PCR ROT measurements associated with the first library.

17. The method of claim 16, wherein performing the launch verification further comprises determining whether the unseal operation is successful.

18. The method of claim 17, wherein the unseal operation is successful upon a determination that the expected ROT measurements match the current PCR ROT measurements associated with the first library.

19. The method of claim 18, wherein the unseal operation is unsuccessful upon a determination that the expected ROT measurements do not match current PCR ROT measurements.

20. At least one computer readable medium having instructions stored thereon, which when executed by one or more processors, cause the processors to:
generate a launch control policy (LCP) comprising a plurality of measured launch environment (MLE) elements associated with one or more libraries of a software application;
deploy the LCP to generate root of trust (ROT) measurements; and
perform launch verification to execute the one or more libraries upon execution and verify integrity of the one or more libraries based on the associated MLEs and the ROT measurements.

21. The computer readable medium of claim 20, wherein deploying the LCP comprises storing an expected ROT measurements in a non-volatile memory.

22. The computer readable medium of claim 20, wherein performing the launch verification comprises executing a first library and invoking an unseal operation to verify to integrity of the first library.

23. The computer readable medium of claim 22, wherein the unseal operation comprises:
retrieving the expected ROT measurements associated with the first library from the non-volatile memory; and
comparing the expected ROT measurements with current PCR ROT measurements associated with the first library.
